(19) United States
(12) Patent Application Publication
(10) Pub. No.: US 2008/0189185 A1
(43) Pub. Date: Aug. 7, 2008

(54) Account Opening Method

(75) Inventors: Taiichi Matsuo, Tokyo (JP); Kosuke Motomura, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EBANK CORPORATION, Chiyoda-ku, Tokyo (JP)

(21) Appl. No.: 12/063,364

(22) PCT Filed: Aug. 8, 2006
(86) PCT No.: PCT/JP2006/315727

§ 371 Date: Feb. 8, 2008

(30) Foreign Application Priority Data
Aug. 10, 2005 (JP) 2005-231512

(51) Int. Cl. G06Q 30/00; G06Q 40/00

(52) U.S. Cl. 705/21; 705/35; 705/23

(57) ABSTRACT

A bank account opening method capable of opening a bank account easily, safely and reliably only by a user and financial institution is provided. In the method for opening an account to a financial institution, an identification document is converted into digital data and the digital data of the identification document is sent to a server of the financial institution via a web content for opening an account, provided from the server of the financial institution, or via e-mail.

### FIELD OF THE INVENTION

The present invention relates to an electronic payment system, electronic payment method and program for payment transaction over a computer network such as the Internet. More particularly, it relates to a method for opening an account in an electronic payment system safely and reliably with saving troubles and cost.

### BACKGROUND OF THE INVENTION

In recent years, various multimedia environments such as WWW (World Wide Web) have been developed against a background of progression of open network environment such as the Internet. Especially, recently, so-called Internet business (e-business) providing specific services by use of the Internet has been proposed and operated.

In such the Internet business (e-business), various types of services are being provided over a network, and the payment transaction in these services can be carried out on the network.

Moreover, net-banks (electronic banks) are being operated for payment for items and services provided on the network. In addition, ordinary banks also provide various services using network.

When a customer opens a new account at a financial institution such as a bank, the customer is required to show an identification document (copy of driver's license, residency card, copy of health insurance card, copy of passport and the like) for identification purposes. The financial institution checks the contents of the identification document carefully and send related documents (cash card and the like) to his/her address described in the documents.

Commonly, the customer shows the identification document such as a copy of driver's license, residency card, copy of health insurance card, copy of passport and the like by delivering or bringing them to the bank by themselves.

Japanese published unexamined patent application 2001-311640 discloses a method for opening an account of a user automatically, in which a bank receives applicant information such as name, address and applicant number transmitted from the user terminal at the account opening, and also receives contract information such as name, address and contractor number transmitted from the business enterprise system, and compares the applicant information with the contractor information. And, on agreement both information, it is determined that the user identification is authorized and then a new account of the user is opened.

This method makes it possible for the user to reduce labor for application procedure required to open a new bank account. And, the financial institutions such as banks can also reduce labor and time for opening an account.

### DISCLOSURE OF THE INVENTION

### Problems to be Solved by the Invention

However, according to the above method for opening an account, the user has to send or bring the identification document such as copy of driver's license, residency card, copy of health insurance card, copy of passport and the like, which are printed on a paper, to the bank directly. This causes quiet troublesome works to the user. Besides, since such identification document is a print paper on which an original of the drivers' license and the like is copied, letters and photographs of the user face printed on the print paper may become unclear. In addition, since such identification document is stored in a paper form only, the storage and management of the paper needs troublesome tasks and the identification document deteriorates with age.

According to the method disclosed in Japanese published unexamined patent application 2001-311640, the business enterprise system storing the user information has to be connected to the user terminal using the same network and financial institution's system so as to be able to browse personal information. So, this necessitates intervening of a third party between the user and the financial institution and causes security loads to the business enterprise.

In order to solve the above problems, an object of the present invention is to provide a bank account opening method capable of opening a bank account easily, safely and reliably only by a user and financial institution.

### Means for Solving the Problems

To accomplish the above object, according to the present invention, there is provided a method for opening an account to a financial institution comprising steps of: in a mobile terminal, downloading a dedicated application software for opening an account available for a mobile-phone, which are provided by a web content for opening an account; in said mobile terminal, by use of said downloaded application software for a mobile-phone, sending identification information including at least name, address and birth date, which is input by an applicant, to a server of the financial institution, connected to the said mobile terminal via a network; in said server of the financial institution, storing the identification information while being associated with a registry number for identifying the identification information in an application information database; in said mobile terminal, obtaining said registry number; in said mobile terminal, by use of said application software for a mobile-phone, sending digital data generated by photographing the identification document with a camera mounted on said mobile terminal together with the registry number to said server of the financial institution; in said server of the financial institution, storing character data based on said digital data of the identification document while being associated with the registry number in said application information database; and in said server of the financial institution, checking the character data based on the digital data of the identification document associated with the registry number and the identification information associated with the registry number, and then storing the identification information in an account database as new account information.

To accomplish the above object, according to the present invention, there is also provided a method for opening an account to a financial institution comprising steps of: in a PC terminal, entering identification information including at least name, address and birth date, which is input by an applicant, via a web content for opening an account, which is provided by a server of the financial institution; in said server of the financial institution, storing the identification information, input via the web content, while being associated with a registry number for identifying the identification information in an application information database; in said server of the financial institution, generating a two-dimensional code which is an information code including applicant identifying information containing the identification information or the registry number and also including URL (Uniform Resource Locator) information of a web page for downloading a dedicated application software for opening an account available for a mobile-phone, and providing the code to said PC terminal as a web content; in a mobile terminal in which said two-dimensional code is read, downloading said application software inheriting the user information, such as the applicant identifying information; in the mobile terminal, by use of said downloaded application software for a mobile-phone, sending digital data generated by photographing the identification document with a camera mounted on said mobile terminal together with the applicant identifying information to said server of the financial institution; in said server of the financial institution, storing character data based on the digital data of the identification document while being associated with the registry number identified by the applicant identifying information in said application information database; and in said server of the financial institution, checking the character data based on the digital data of the identification document associated with the registry number and the identification information associated with the registry number, and then storing the identification information in an account database as new account information.

To accomplish the above object, according to the present invention, there is also provided a method for opening an account to a financial institution comprising steps of: in a mobile terminal, entering identification information including at least name, address and birth date, which is input by an applicant, via a web content for opening an account, which is provided by a server of the financial institution; in said server of the financial institution, storing the identification information, input via the web content, while being associated with a registry number for identifying the identification information in an application information database; in said server of the financial institution, generating a web page including URL (Uniform Resource Locator) information of the web page for downloading a dedicated application software for opening an account available for a mobile-phone, associated with applicant identifying information containing the identification information or the registry number, and providing the generated web page to said mobile terminal; in said mobile terminal, by appointing said URL on said mobile terminal, downloading said application software inheriting the applicant identifying information; in said mobile terminal, by use of said downloaded application software for a mobile-phone, sending digital data generated by photographing the identification document with a camera mounted on said mobile terminal together with the applicant identifying information to said server of the financial institution; in said server of the financial institution, storing character data based on the digital data of the identification document while being associated with the registry number identified by the applicant identifying information in said application information database; and in said server of the financial institution, verifying the character data based on the digital data of the identification document associated with the registry number and the identification information associated with the registry number, and then storing the identification information in an account database as new account information.

In a preferred embodiment of the present invention, in the step of, in said mobile terminal, sending the digital data of the identification document to said server of the financial institution, information showing type of the identification document is sent to said server of the financial institution, in said server of the financial institution, the character data based on the digital data of the identification document is generated according to the information showing type of the identification document, and the character data is verified with the identification information.

In another embodiment of the present invention, a method for opening an account to a financial institution comprises steps of: in a mobile terminal, downloading a dedicated application software for opening an account available for a mobile phone, which is provided by a web content for opening an account; in said mobile terminal, by use of the downloaded application software for a mobile-phone, sending identification information including at least name, address and birth date, which is input by an applicant, to a server of the financial institution connected to said mobile terminal via a network; in said server of the financial institution, storing the identification information while being associated with a registry number for identifying the identification information in an application information database; in said mobile terminal, obtaining the registry number; in said mobile terminal, by use of said application software for a mobile-phone, generating digital data by photographing the identification document with a camera mounted on said mobile terminal and then generating character data based on the digital data; in said mobile terminal, by use of said application software for a mobile-phone, sending the character data based on the digital data of the identification document together with the registry number to said server of the financial institution; in said server of the financial institution, storing the character data based on the digital data of the identification document while being associated with the registry number in said application information database; and in said server of the financial institution, checking the character data based on the digital data of the identification document associated with the registry number and the identification information associated with the registry number, and then storing the identification information in an account database as new account information.

In still another embodiment of the present invention, a method for opening an account to a financial institution comprises steps of: in a PC terminal, entering identification information including at least name, address and birth date, which is input by an applicant, via a web content for opening an account, which is provided by a server of the financial institution; in said server of the financial institution, storing the identification information, input via the web content, while being associated with a registry number for identifying the identification information in an application information database; in said server of the financial institution, generating a two-dimensional code which is an information code including applicant identifying information containing the identification information or the registry number and also including URL (Uniform Resource Locator) information of a web page for downloading a dedicated application software for opening an account available for a mobile-phone, and providing the code to said PC terminal as web content; in a mobile terminal in which said two-dimensional code is read, downloading the application software inheriting user information, such as the applicant identifying information; in said mobile terminal, by use of said downloaded application, generating digital data by photographing the identification document with a camera mounted on said mobile terminal, and then generating character data based on the digital data of said identification document; in said mobile terminal, by use of said application software for a mobile-phone, sending the character data based on the digital data of the identification document together with the registry number to said server of the financial institution; in said server of the financial institution, storing the character data based on the digital data of the identification document while being associated with the registry number identified by the applicant identifying information in said application information database; and in said server of the financial institution, checking the character data based on the digital data of the identification document associated with the registry number and the identification information associated with the registry number, and then storing the identification information in an account database as new account information.

In still another embodiment of the present invention, a method for opening an account to a financial institution comprises steps of: in a mobile terminal, entering identification information including at least name, address and birth date, which is input by an applicant, via a web content for opening an account, which is provided by a server of the financial institution; in said server of the financial institution, storing the identification information, input via the web content, while being associated with a registry number for identifying the identification information in an application information database; in said server of the financial institution, generating a web page including applicant identifying information associated with the identification information or the registry number and URL (Uniform Resource Locator) information of a web page for downloading a dedicated application software for opening an account available for a mobile-phone, and providing the generated web page to said mobile terminal; in said mobile terminal, by appointing the URL on said mobile terminal, downloading said application software inheriting the applicant identifying information; in said mobile terminal, by use of said downloaded application software, generating digital data by photographing the identification document with a camera mounted on said mobile terminal, and then generating character data based on the digital data of said identification document; in said mobile terminal, by use of said application software a for a mobile-phone, sending the character data based on the digital data of the identification document together with the registry number to said server of the financial institution; in said server of the financial institution, storing the character data based on the digital data of the identification document while being associated with the registry number identified by the applicant identifying information in said application information database; and in said server of the financial institution, verifying the character data based on the digital data of the identification document associated with the registry number and the identification information associated with the registry number, and then storing the identification information in an account database as new account information.

In order to accomplish the above object, according to the present invention, there is also provided a method for opening an account to a financial institution, wherein an identification document required to submit to the financial institution in order to apply for opening a bank account is converted into digital data at a PC terminal or mobile terminal, and the digital data of the identification document is sent to a server of the financial institution via a web content for opening an account, provided by said server of the financial institution, via a network or e-mail.

In this case, it is also possible to generate the digital data of the identification document by photographing the identification document with a camera mounted on the mobile-phone, and send to said server of the financial institution via a web content for opening an account, provided by said server of the financial institution, or via a network or e-mail.

It is also possible to access a web site for opening an account providing the web content for opening an account by clicking on a hyperlink for the web page which is a link source, or by reading said two-dimensional code using a mobile-phone provided with a function capable of reading a two-dimensional code which is an information code, wherein the hyperlink information includes URL (Uniform Resource Locator) information of the web site and user information which is inherited to the web site from said link source, and said two-dimensional code includes URL (Uniform Resource Locator) information of the web site and the user information which is inherited to the web site.

It is also possible to execute the dedicated application software for opening an account available to a mobile-phone at said mobile-phone to allow applying for opening a bank account to the financial institution, generating digital data of the identification document, and sending the digital data to said server of said financial institution continuously and consistently.

It is also possible to execute the dedicated application software for opening an account available for a mobile-phone by linking to the web page including a button for downloading said application software, by selecting said button for downloading on the web page to download said application software to said mobile-phone via the web page, and then by activating said application software, at said mobile-phone.

It is also possible to accomplish an application for opening a bank account to the financial institution by inputting identification information to said server of the financial institution from said PC terminal via a web content for opening an account, to display a two-dimensional code which is an information code including applicant identifying information, such as the identification information, and URL (Uniform Resource Locator) information of a web page for downloading the dedicated application software for opening an account available for a mobile-phone on said PC terminal when the application for opening an account is completed by completing the input, to read said two-dimensional code by said mobile-phone provided with a function capable of reading a two-dimensional code thereby to link to the web page with the user information such as the applicant identifying information being inherited, to select a button for downloading on the web page to download said application software to said mobile-phone via the web page with the user information being inherited, and to activate said application software to generate digital data of the identification document and to send the digital data to said server of said financial institution, following the application for opening a bank account.

It is also possible to accomplish an application for opening a bank account to the financial institution by inputting identification information to said server of the financial institution from said mobile-phone via a web content for opening an account, to select a button for sending the digital data on the web page including buttons for selecting the method for sending the identifying document, at said mobile-phone, when the application for opening an account is completed by completing the input, in which hyperlink information obtained by selecting the button contains the applicant identifying information, such as the identification information, and the URL (Uniform Resource Locator) information of the web page for downloading the dedicated application software for opening an account available for a mobile-phone thereby to link to the web page for downloading with the user information, such as the applicant identifying information, being inherited; to select a button for downloading on the web page for downloading to download said application software to said mobile-phone via the web page with the user information being inherited, and to activate said application software to generate digital data of the identification document and send the digital data to said server of said financial institution, following the application for opening a bank account.

At said server of said financial institution, when the character data converted from the received digital data of the identification document is not recognized, it is also possible to automatically sent notification for prompting to generate the digital data of the identification document and send it again to the transmitter of the digital data of the identification document via a network or e-mail and to inform to the user via the web content for opening an account or the dedicated application software for opening an account available for a mobile-phone, or via e-mail, at said PC terminal or mobile terminal.

It is also possible to convert the received image information of the digital data of the identification document into the character data by executing an OCR software, at said server of the financial institution.

It is also possible to send the digital data of the identification document with an optimized condition in photograph size and the like to said server of the financial institution.

### EFFECT OF THE INVENTION

According to the method for opening an account of the present invention, a series of steps for generating the digital data of the identification document, sending the digital data to the server of the financial institution via a network or e-mail, recognizing the sent data by executing OCR software and the like, certificating for opening an account and informing recognition error and certification error, and the like, are automatically carried out so that a bank account can be opened easily, safety and reliably only by the user and financial institution. And, since the identification document is in form of digital data, the image can be stored clearly without degrading with age and it becomes difficult to fake the data. Accordingly, the invention has advantageous for both the user and financial institution.

Executing the dedicated application software for opening an account available for a mobile-phone at the mobile-phone allows applying opening a bank account to the financial institution, generating the identification document, sending to the server of the financial institution and the like continuously and consistently according to guidance. Also, it makes possible to reduce a number of accesses to the server of the financial institution as small as possible. Accordingly, higher security can be allowed. And, a function capable of reading a two-dimensional code allows to access directly to the web content for opening an account and to carry out the steps necessary for opening an account using a mobile-phone after the completion of applying for opening an account, whereby a procedure for opening an bank account becomes easy, convenient and reliable.

### BRIEF DESCRIPTION OF THE DRAWINGS

FIG. 1 is a block diagram showing one embodiment of a system to carry out a bank account opening method according to the present invention;

FIG. 2 is a block diagram showing an embodiment of the electronic bank server constituting the system to carry out the bank account opening method according to the present invention;

FIG. 3 is a flowchart showing the bank account opening method according to the present invention;

FIG. 4 is a flowchart showing the bank account opening method according to the present invention;

FIG. 5 is a flowchart showing another embodiment of a bank account opening method according to the present invention;

FIG. 6 is a flowchart showing still another embodiment of a bank account opening method according to the present invention; and

FIGS. 7A to 7C are drawings showing embodiments of images displayed on the window of display of the mobile-phone during the executing the processes of FIGS. 3 and 4; and

FIGS. 8A to 8C are drawings showing embodiments of images displayed on the window of display of the mobile-phone during the executing the processes of FIGS. 3 and 4.

### DETAILED DESCRIPTION OF EMBODIMENT OF THE INVENTION

Hereinafter, a preferred embodiment of bank account opening method of the present invention will be concretely described with reference to the drawings.

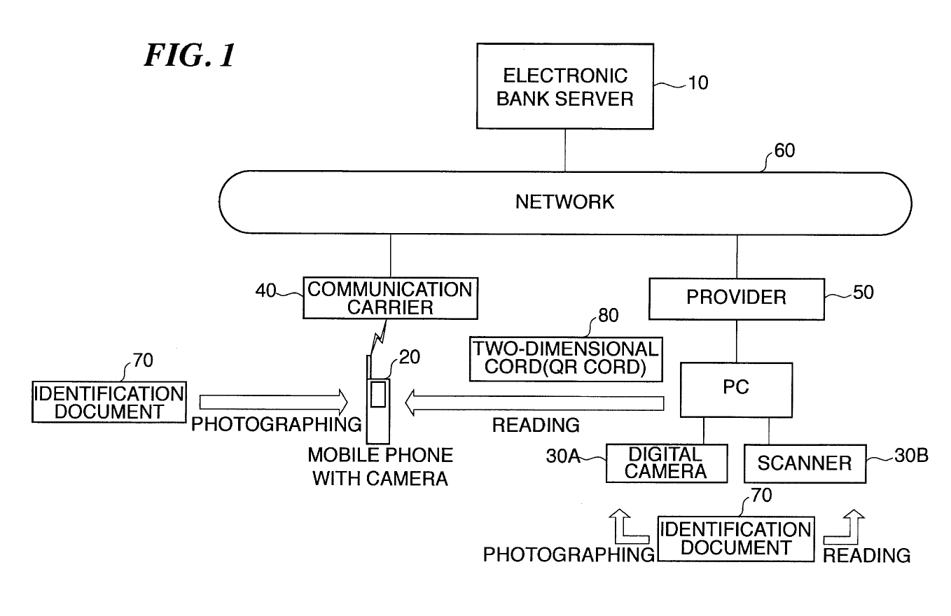

FIG. 1 is a block diagram showing one embodiment of a system to carry out a bank account opening method according to the present invention.

The system comprises an electronic bank server 10 of a financial institution possessing account information and the like of a user; a terminal such as a mobile phone with camera 20 and PC (personal computer) 30 which is a communication device to transmit identification information and image data of a identification document, which are required to open a new account, to the electronic bank server 10 (referring to as terminals 20 and 30); a digital camera 30A and scanner 30B which are connected to the PC 30 and convert the identification document into digital data; a communication carrier 40 of the mobile phone with camera 20; a provider 50 of the PC 30; and a network 60 which connects the electronic bank server 10, mobile phone with camera 20, PC 30, communication carrier 40 and provider 50 so as to be able to communicate each other.

The network 60 can be constituted by use of the Internet or Intranet.

An original or copy 70 of documents under defined standards of identification procedures, such as a driver's license, various types of health insurance cards, passport, copy of residency card, seal registration certificate, foreign resident' registration card and the like (referring to as identification document), is photographed with a camera of the mobile phone with camera 20 or digital camera 30A, or read with the scanner 30B to convert into digital data. The digital data is transmitted to the electronic bank server 10 via a web content for opening an account or e-mail from the mobile phone with camera 20 or PC 30 (or, via just the network 60 when a dedicated application software for opening an account available for a mobile-phone is executed, as described later).

When the mobile phone with camera 20 has a function to read a two-dimensional code (QR code (Trade Mark)) which is an information code, reading a two-dimensional code 80 including URL (Uniform Resource Locator) information of the web content published on a home page of the financial institution allows direct access to a website for opening an account. Besides, as described below, after applying for opening an account using the PC 30 has been completed, reading the two-dimensional code 80 including applicant identification information (described later) displayed on the PC 30 allows to carry out next steps (procedures) required to open a bank account at the mobile phone with camera 20.

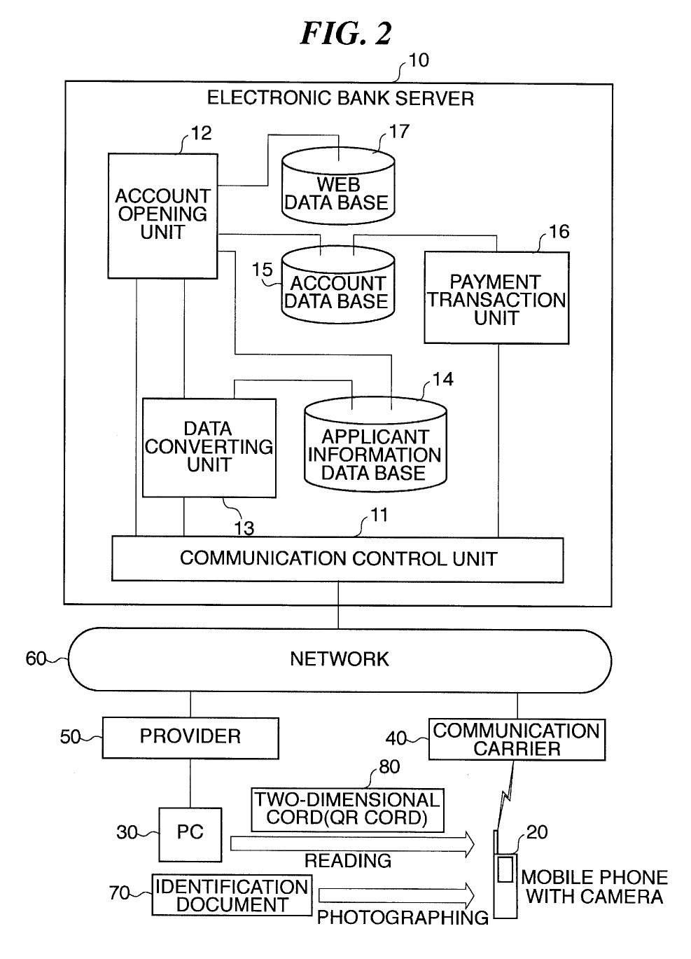

FIG. 2 is a block diagram showing an embodiment of the electronic bank server 10 constituting the system to carry out the bank account opening method according to the present invention.

The electronic bank server 10 is provided with a communication control unit 11 connected to the network 60 so as to be able to communicated each other; a bank account DB (Data Base) 15 storing account information; a payment transaction unit 16 executing payment transaction according to the account information stored in the bank account DB 15; a data conversion unit 13 converting digital data (image information) received from the terminals 20 and 30 via the network 60 or e-mail into character data automatically; a web DB 17 storing a web content for opening an account (including a dedicated application software for opening an account available for a mobile-phone); a bank account opening processing unit 12; and an application information DB 14 storing the identification information received at the bank account opening processing unit 12 and the character data converted at the data conversion unit 13. The bank account opening processing unit 12 has following procedures: receiving the identification information stored in the web DB 17, which is input from terminals 20 and 30, via the network 60; generating digital data (image information) of the identification documents; providing the web content to communicate the digital data (image information) (or the dedicated application software for opening an account available for a mobile-phone); receiving the input identification information via the web content (or via a procedure by executing the dedicated application software for opening an account available for a mobile-phone) from the terminals 20 and 30; and comparing the character data converted at the data conversion unit 13 with the received identification information, where a new bank account would be opened by storing new account information in the bank account DB 15 when the character date coincides with the received information.

In the account opening processing unit 12, the character data stored in the application information DB 14 is compared with the identification information, when the data matches the information, a new account is opened in the bank account DB 15.

And, after the bank account is opened, the account opening processing unit 12 informs the completion of opening a new bank account to the terminals 20 and 30 via e-mail.

The data conversion unit 13 converts the digital data (image information) into character data by executing OCR software.

When the data conversion unit 13 determines that the character data converted from the digital data (image information) can not be recognized, the bank account opening processing unit 12 automatically sends an error notification for prompting to re-generate the digital data (image information) of the identification information and re-send the re-generated digital data via the network or e-mail to the transmitter of the digital data, and informs the user via the web content for opening an account or a procedure executing the dedicated application software for opening an account available for a mobile-phone, or through e-mail.

When the identification information is input from the PC 30 to the electronic bank server 10 via the web content in order to apply for opening an account and thereby to complete an applying for opening an account, the bank account opening processing unit 12 displays a two-dimensional code (QR code (Trade Mark)) 80 which is an information code including applicant identifying information, such as identification information, and URL (Uniform Resource Locator) information of the web page for downloading the dedicated application software for opening an account available for a mobile-phone, on the PC 30 via the web content for opening an account.

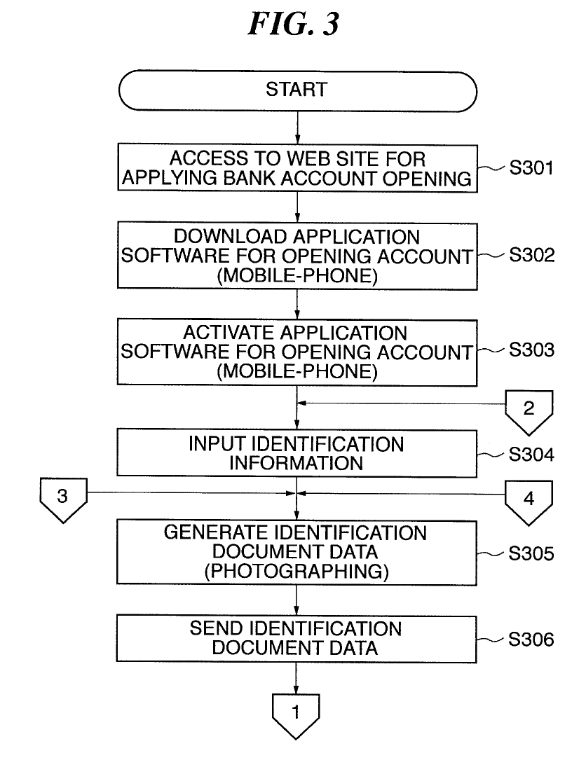

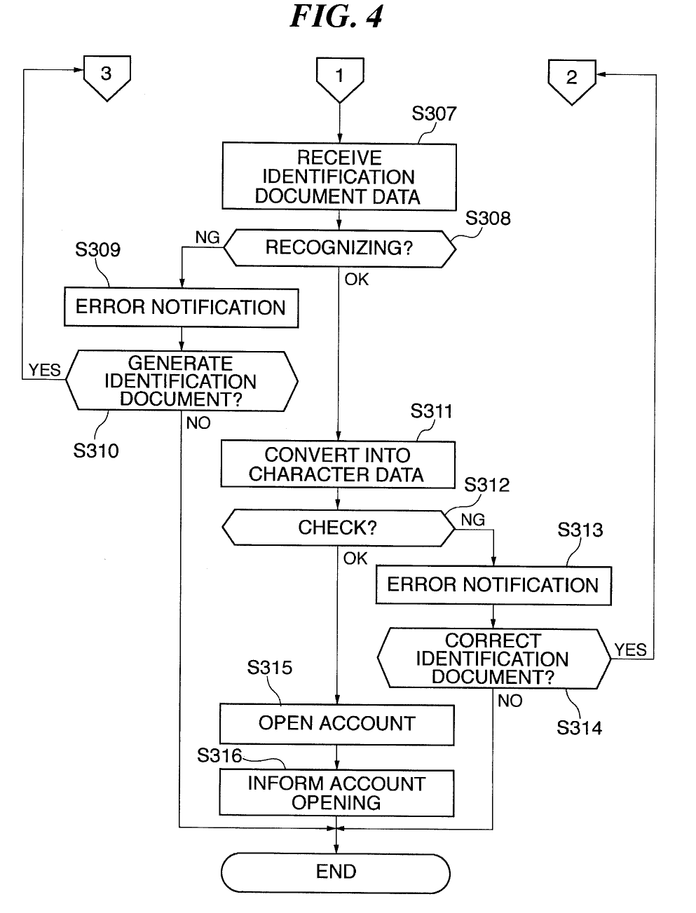

FIGS. 3 and 4 are flowcharts showing the bank account opening method according to the present invention.

In FIGS. 1 to 4, the user accesses the electronic bank server 10, which provides the web content for opening an account, from the mobile phone with camera 20 or PC 30 in order to apply for opening an account (step 301).

The access to website for opening an account of the electronic bank server 10, providing the web content for opening an account, may be guided by an ordinary link (or may be guided by a hyperlink for the web page of link source). The hyper link information can incorporate not only the URL (Uniform Resource Locator) information of the website but also the user information itself sent from the link source so that the information of the link source can be inherited to the website.

When the mobile phone with camera 20 has a function to read a two-dimensional code (QR code (Trade Mark)) which is an information code, reading the two-dimensional code (QR code (Trade Mark)) capable of incorporating not only the URL (Uniform Resource Locator) information of the website for opening an account published on a homepage of the financial institution but also the user information allows to access the website for opening an account directly and also to inherit the user information to the website.

The procedure for opening an account (described later) includes a conventional bank account opening procedure performed by communication between the electronic bank server 10 and the PC 30 or mobile phone with camera 20 every behavior via the web content for opening an account provided by the website for opening an account (the electronic bank server 10). In addition, when the mobile phone with camera 20 is provided with a function to execute Java (Trade Mark) program and the like (for example, available for i-application (Trade Mark)), executing the dedicated application software for opening an account available for a mobile-phone allows applying for opening an account to the electronic bank server 10; generating the digital data of the identification document 70; and sending it to the electronic bank server 10 consistently and continuously according to guidance, as described later.

In this case, on the mobile phone with camera 20, by selecting a downloading button on a main menu window (web page) opened by accessing the web site for opening an account (or, on a window (web page) for downloading the dedicated application software for opening an account available for a mobile-phone which is linked by selecting on the main menu window (web page)), the dedicated application software for opening an account available for a mobile-phone is downloaded to the mobile phone with camera 20 via the web content (aforesaid web page) for opening an account from the electronic bank server 10 (step 302).

Then, on the mobile phone with camera 20, the downloaded application software for opening an account available for a mobile-phone is automatically activated (step 303).

In order to apply for opening a new account again using the mobile phone with camera 20, the dedicated application software for opening an account available for a mobile-phone, which has been downloaded and stored, is called up (activated). Accordingly, it is not necessary to carry out the step for accessing the web site for opening an account at the start, and the like.

As described above, the execution of the dedicated application software for opening an account available for a mobile-phone at the mobile phone with camera 20 allows applying for opening an account to the electronic bank server 10, generating the digital data (image information) of the identification document 70 and sending to the electronic bank server 10 consistently and continuously according to guidance. Through the performances, the steps processed by executing the application software do not require access to the electronic bank server 10. This differs from a conventional account opening procedures to communicate with the electronic bank server 10 for every step via the web content for opening an account. Accordingly, this requires minimum access to the electronic bank server 10 on processing sequence by executing the dedicated application software for opening an account available for a mobile-phone. Thus, this is advantageous on operation of the electronic bank server 10 because it becomes possible to reduce load applied to the electronic bank server 10 and have higher security.

The steps 302 and 303 are not applied for a conventional account opening procedure carried out via the web content at the user terminal.

Then, the identification information (name, address, birth date and the like) are input to the electronic bank server 10 from the mobile phone with camera 20 or PC 30 via the web content for opening an account, or through processing by executing the dedicated application software for opening an account available for a mobile-phone to apply for opening a new account (step 304). After the input is completed, a registration number is provided from the bank account opening processing unit 12. The bank account opening processing unit 12 stores the received identification information (name, address, birth date and the like), which is associated with the registry number, in the application information DB 14.

Then, the electronic bank server 10 requires submitting the identification document for user identification. In response to the request, the user prepares the identification document 70 such as his driver's license, various types of health insurance cards, passport, copy of residency card, seal registration certificate and foreign resident' registration card and then generates digital data (image information) of the identification document (step 305).

At the step, the digital data (image information) of the identification documents can be generated by photographing the driver's license, various types of health insurance cards, passport and the like with the camera of the mobile phone with camera 20. Alternatively, the digital data can be also generated by photographing the driver's license, various types of health insurance cards, passport and the like with the digital camera 30A or reading such documents using the scanner 30B.

The digital data (image information) of the identification documents generated by use of the mobile phone with camera 20 is sent to the electronic bank server 10 from the mobile phone with camera 20 via the web content for opening an account (or, via only the network 60 in processing by executing the dedicated application software for opening an account available for a mobile-phone), or via e-mail. Alternatively, the digital data (image information) of the identification documents generated by use of the digital camera 30A or scanner 30B is input to the PC 30 and is sent to the electronic bank server 10 from the PC 30 via the web content for opening an account or e-mail (step 306).

The digital data (image information) of the identification document 70 is sent with an optimized condition in a necessary resolution, photograph size, file size, communication speed and the like. The sufficient resolution of the digital data (image information) of the identification document 70 is about 300,000 pixels.

The electronic bank server 10 receives the digital data (image information) of the identification document 70 in which the identification information (including name, address, birth date, expiration date of the document, registry number and the like) is described (step 307). Then, the data conversion unit 13 receives the received digital data (image information) of the identification document 70 and recognizes the name, address, birth date, expiration date of the document, registry number and the like (step 308). If they can be recognized, the data conversion unit 13 converts them to character data and stores in the application information DB 14 (step 311).

The digital data (image information) of the identification document 70 and the character data are registered and managed with a registry number assigned. The digital data (image information) of the identification document 70 and the character data can be outputted on a display or paper at the financial institutions to be checked. The data converting unit 13 executes OCR software to recognize the digital data (image information) automatically and convert into character data.

If the digital data can not to be recognized at the step 308, error notification to prompt for generating the digital data (image information) of the identification information 70 and for sending the data again is automatically sent to the mobile phone with camera 20 or PC 30, which are transmitter of the digital data of the identification document 70, via the net-work 60 or e-mail. On receiving the error notification, the mobile phone with camera 20 or PC 30 informs the user via the web content for opening an account, or through processing by executing the dedicated application software for opening an account available for a mobile-phone, or e-mail (step 309). When the user generates the digital data (image information) of the identification document 70 again, the processes from the step 305 are repeated.

The bank account opening processing unit 12 checks the identification by comparing the identification information with the character data according to the registry number (step 312). When the character data matches the identification information and the expiration date of the identification document is accepted, new account information is stored to the bank account DB 15 and therefore a new bank account is opened (step 315).

When the new bank account is opened, the bank account opening processing unit 12 announces a completion of applying for opening an account to the mobile phone with camera 20 or PC 30 by e-mail (step 316). And, documents related to the transaction (cash card and the like) are sent to the user whose name and address are described on the identification document 70, completing the processing for opening an account.

When the identification is not confirmed at the step 312, error notification is automatically sent to the mobile phone with camera 20 or PC 30 via the net-work 60 or e-mail. On receiving the error notification, the mobile phone with camera 20 or PC 30 announces to the user via the web content for opening an account, or through processing by executing the dedicated application software for opening an account available for a mobile-phone, or e-mail (step 313). When the user corrects the identification information (step 314), the processes from the step 304 are repeated.

The steps from 307 to 316 (except for steps 310 and 314) can be automatically carried out by processing the digital data of the identification document at the electronic bank server 10 or the financial institution system.

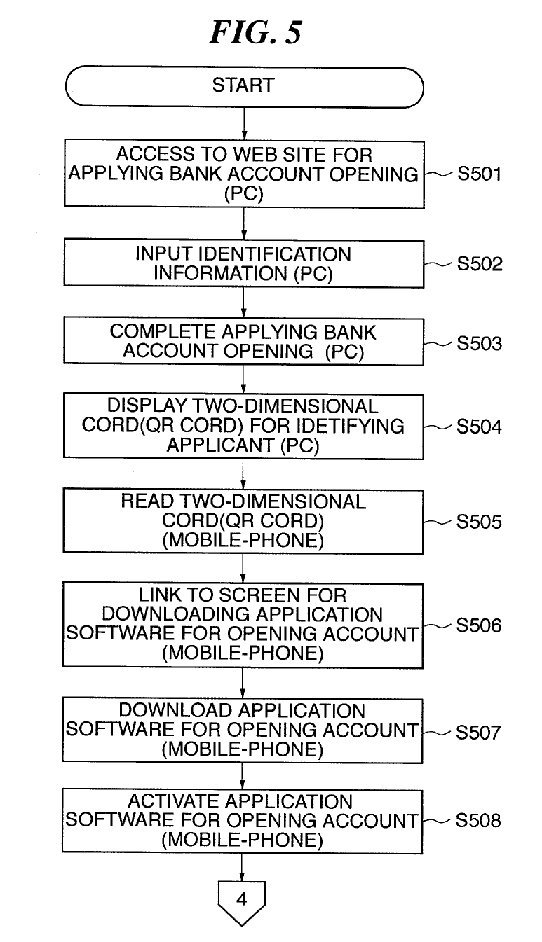

FIG. 5 is a flowchart showing another embodiment of a bank account opening method according to the present invention.

The flowchart shows a bank account opening method capable of applying an account opening from the PC 30 and then performing subsequent steps necessary for opening an account by a mobile-phone.

In FIGS. 1 to 5, a user accesses the electronic bank server 10 providing the web content for opening an account from the PC 30 in order to apply for opening a new bank account (step 501 (same as the step 301)).

Then, the identification information (name, address, birth date and the like) are input to the electronic bank server 10 from the PC 30 via the web content for opening an account to apply for opening a new bank account (step 502 (same as the step 304)). After the input is completed, a registration number is provided from the bank account opening processing unit 12 of the electronic bank server 10. The bank account opening processing unit 12 stores the received identification information (name, address, birth date and the like), which is associated with the registration number, in the application information DB 14.

At this point, the application for opening an account by use of the PC 30 is completed (step 503). Then, the electronic bank server 10 generates a two-dimensional code (QR code (Trade Mark)) which is an information code including the applicant identifying information, such as the identification information, and the URL (Uniform Resource Locator) information of a window (web page) for downloading the dedicated application software for opening an account available for a mobile-phone and displays on the PC 30 via the web content for opening an account (step 504).

On the other hand, when the mobile phone with camera 20 has a function to read a two-dimensional code (QR code (Trade Mark)) which is an information code, the two-dimensional code (QR code (Trade Mark)) displayed on the PC 30 is read by the mobile phone with camera 20 (step 505). Then, the URL (Uniform Resource Locator) information for downloading the dedicated application software for opening an account available for a mobile-phone and the applicant identifying information (user information) such as the identification information, which are included in the two-dimensional code, are extracted. The user information is successively inherited and linked to the window (web page) (step 506). By selecting a button for downloading on the window (web page), the dedicated application software for opening an account available for a mobile-phone is downloaded to the mobile-phone with the user information being inherited from the electric bank server 10 via the web content (web page) (step 507). The dedicated application software for opening an account available for a mobile-phone is automatically activated (step 508).

In the mobile phone with camera 20, executing the dedicated application software for opening an account available for a mobile-phone can continuously carry out a series of steps from the step 305, including generating digital data (image data) of the identification document 70, sending the digital data (image information) to the electronic server 10 and the like, following the application for opening an account to the financial institutions, according to the inherited user information including the applicant identifying information such as the identification information at the applying for opening an account.

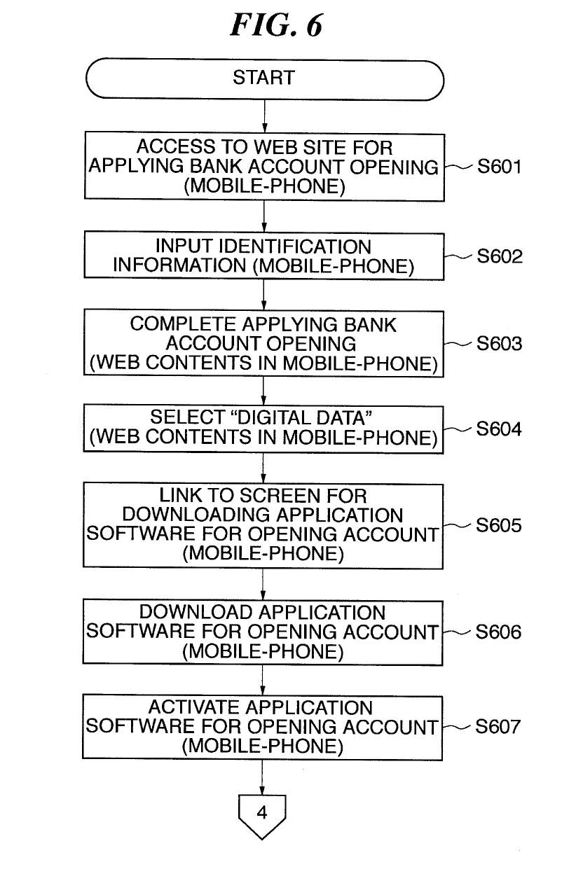

FIG. 6 is a flowchart showing still another embodiment of a bank account opening method according to the present invention.

The flowchart shows a bank account opening method capable of applying for opening a new bank account via the web content for opening an account provided from the web site for opening an account (the electronic bank server 10), which is normal procedure for opening an account, at the mobile phone with camera 20 similar to the PC 30 and then performing subsequent steps necessary for opening an account by executing the dedicated application software for opening an account available for a mobile-phone.

In FIG. 6, the steps 601 to 603 corresponding to the application for opening an account to the completion of applying are the same as the steps 501 to 503 using the PC 30 in FIG. 5, and accordingly will not be described.

After the completion of the applying for opening an account (step 603), at the mobile phone with camera 20, a button for “sending digital data” is selected on a next displayed window (web page) including buttons capable of selecting methods for sending the identification documents (step 604). Consequently, the applicant identifying information such as the identification information and the URL (Uniform Resource Locator) information for downloading the dedicated application software for opening an account available for a mobile-phone, which are included in the hyperlink information of the selected button, causes to link to the window (web page) for downloading the application software with the user information such as the identification information being inherited (step 605). By selecting a button for downloading on the window (web page), the dedicated application software for opening an account available for a mobile-phone the user information is downloaded to the mobile-phone 20 with the user information being inherited via the web content (the web page for downloading) for opening an account (step 606). Then, the dedicated application software for opening an account available for a mobile-phone is automatically activated (step 607).

On the mobile phone with camera 20, as with FIG. 5, the dedicated application software for opening an account available for a mobile-phone can continuously carry out a series of steps from the step 305, including generating the digital data (image data) of the identification document 70, sending the digital data (image information) to the electronic server 10 and the like, following the application for opening an account to the financial institution, according to the inherited user information including the applicant identifying information such as the identification information at the applying for opening an account.

In case of applying for opening an account using a mobile device such as the mobile phone with camera 20, generating the digital data (image information) of the identification documents 70 and sending the data can be carried out by executing the application software. These procedures seem to be most effective in utilization of the application software.

One embodiment (the first method) of the bank account opening method according to the present invention described with reference to FIGS. 3 and 4, another embodiment (the second method) of the bank account opening method according to the present invention described with reference to FIG. 5 and still another embodiment of the bank account opening method according to the present invention described with reference to FIG. 6 will be complemented.

The first method comprises steps of:

(a) in the mobile-phone 20, downloading the dedicated application software for opening an account available for a mobile-phone, provided by the web content for opening an account;
(b) in the mobile-phone 20, by use of the downloaded dedicated application software for opening an account available for a mobile-phone, sending the identification information including at least name, address and birth date, input by the applicant, to the electronic bank server 10 connected via the network;
(C) in the electronic bank server 10, storing the identification information while being associated with the registry number for identifying the identification information in the applicant information DB 14;
(d) in the mobile-phone 20, obtaining the registry number;
(e) in the mobile-phone 20, by use of the application software for a mobile-phone, sending the registry number and the digital data of the identification document generated by photographing with the camera mounted on the mobile phone with camera 20 to the electronic bank server 10;
(f) in the electronic bank server 10, storing the digital data while being associated with the registry number in the applicant information DB 14;
(g) in the electronic bank server 10, checking the character data based on the digital data of the identification document associated with the registry number and the identification information associated with the registry number and then storing the identification information to the bank account DB 15 as new bank account information.

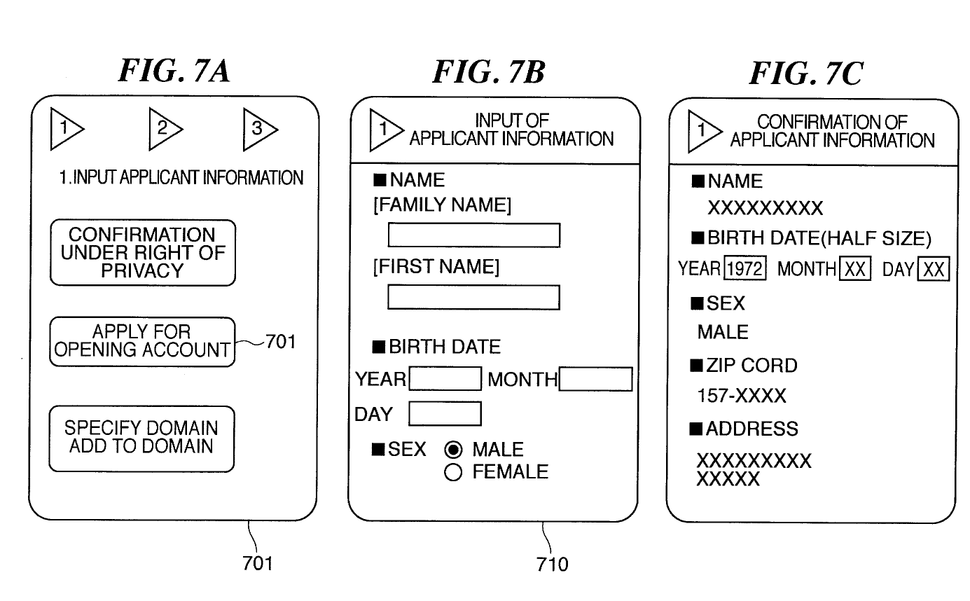

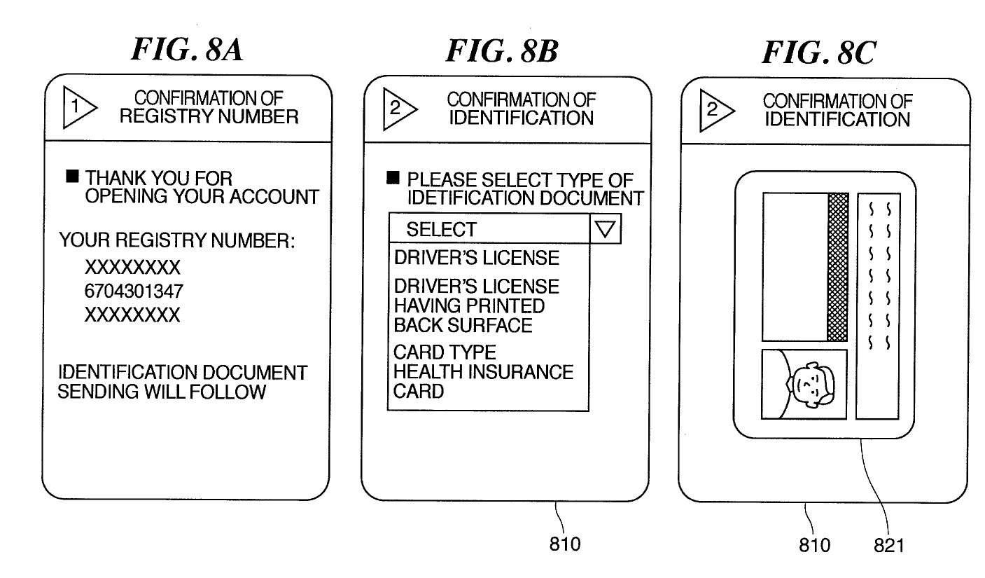

FIGS. 7A to 7C and FIGS. 8A to 8C are drawings showing embodiments of images displayed on the window of display of the mobile-phone during the executing the processes of FIGS. 3 and 4.

At step 301 of FIG. 3, on the window of the display of the mobile-phone 20, an image 700 shown in FIG. 7A is displayed. Pushing “applying an account opening” button 701 by the user makes the application software for a mobile-phone to be downloaded and activated (the step (b), the steps 302 and 303 in FIG. 3). On the window of the display of the mobile-phone 20, an input image 710 for inputting the identification information is displayed as shown in FIG. 7B. As shown in the inputting image 710, for example, the identification information includes name and birth date. The image successively displayed on the window of the display of the mobile-phone 20 includes a section to which address is input, which is not shown in FIG. 7B.

The identification information including name, address and birth date input by the user is sent to the electronic bank server 10 (the step (C) and the step 304 in FIG. 3). As shown in FIG. 7C, it is preferable to display the identification information input by the user on the display of the mobile-phone 20 and to request verification of the user. After the user verifies (and operating of the mobile-phone 20), the bank account opening processing unit 12 of the electronic bank server 10 stores the identification information while being associated with the registry number in the application information DB 14 (the step (C) and the step 304 in FIG. 3). The registry number is sent to the mobile-phone 20. FIG. 8A is a drawing showing an embodiment of image including the registry number displayed on the window of the display of the mobile-phone 20 in response to application for opening an account at the electronic bank server 10.

When the digital data of the identification document is generated, as shown in FIG. 8B, the user is made to select the type of the identification document. For example, the image 810 shown in FIG. 8B shows a driver's license, driver's license having printed back surface, card type health insurance card as the type of the identification document. Other types (another type health insurance card, passport and resident card) may be available. The type of the identification document selected by the user is sent to the electronic bank server 10 together with the digital data generated by photographing the identification document with the camera.

The user operates the camera mounted on the mobile phone with camera 20 to photograph the identification document and generate the digital data of the identification document (step 305 in FIG. 3). FIG. 8C shows an embodiment of an image of the identification document photographed with the camera of the mobile-phone 20. In the embodiment of FIG. 8C, the driver's license is selected as the type of the identification document and the image 820 shows the photographed drivers license (shown as 821).

The user operates to send the digital data of the identification document with the registry number and the type of the identification document to the electronic bank server 10 (the step (e) and step 307 of Fig.).

The electronic bank server 10 recognizes the received digital data using an OCR to obtain character data (the steps 308 and 311 of FIG. 3). The electronic server 10 identifies regions required to recognize character according to the type of the identification document sent with the digital data of the identification document from the mobile-phone 20. For example, in a case of driver's license, the uppermost left region is a space for name, the uppermost right region is a space for birth date and the third region from the top is a space for address. Accordingly, the data converting processing unit 13 of the electronic server 10 recognizes the character on the predetermined regions and obtains character data based on a pre-prepared template including information of the regions necessary for recognizing character printed on the driver's license. In other types of the identification document, a template is prepared for every type of the identification documents, and the data converting processing unit 13 recognizes the character in the region showed by the prepared template to obtain character data.

The obtained character data is associated with the registry number and stored in the application information DB 14 (the step (f), the step 311 of FIG. 3).

The bank account opening processing unit 12 reads the identification information associated with the registry number from the application information DB 14 according to the registry number sent with the digital data of the identification document, and verifies the identification information and the character data based on the digital data of the identification document obtained by the data converting processing unit 13 (the step 312 of FIG. 3). Here, each value of items (name, address, birth date and the like) of the identification information stored in the application information DB 14 is compared with each value of the corresponding items of the character data. When values of all items are same, the identification information is stored in the bank account DB 15 as new account information (the step (g), the step 315 of FIG. 3). The identification information is stored in the bank account DB 15 as account information and therefore a new bank account is opened.

Next, the second method shown in FIG. 5 will be complemented.

The second method comprises the steps of:

(h) in the PC 30, entering the identification information including at least name, address and birth date, input by the applicant, via the web content for opening an account, which is provided by the electronic bank server 10:
(i) in the electronic bank server 10, storing the identification information, which is input via the web content, while being associated with the registry number for identifying the identification information in the application information DB 14;
(j) in the electronic bank server 10, generating the two-dimensional code which is an information code including the applicant identifying information containing the identification information or the registry number and also including the URL (Uniform Resource Locator) information of the web page for downloading the dedicated application software for opening an account available for a mobile-phone, and then providing the code to the PC 30 as the web content;
(k) in the mobile-phone 20 in which the two-dimensional code is read, downloading the application software inheriting the user information such as the applicant identifying information;
(e′) in the mobile-phone 20, by use of the downloaded application software for a mobile-phone, sending the applicant identification information and the digital data generated by photographing the identification document with the camera mounted on the mobile phone with camera 20 to the electronic bank server 10;
(f′) in the electronic bank server 10, storing the character data based on the digital data of the identification document while being associated with the registry number identified by the applicant identifying information in the application information DB 14; and
(g′) in the electronic bank server 10, checking the character data based on the digital data of the identification document associated with the registry number and the identification information associated with the registry number and then storing the identification information in the bank account DB 15 as new bank account information.

In the second method, the user inputs the identification information including name, address and birth date via the web content for opening an account displayed on the window of the display of the PC 30 (the step (h), the steps 501 and 502 of FIG. 5). The web page displayed on the window of the PC 30 has the input spaces like an image shown in FIG. 7B. Accordingly, the user operates the PC 30 to input necessary information to each space.

When the electronic bank server 10 stores the identification information while being associated with the registry number in the application information DB 14, the application for opening a bank account using the PC 30 is completed (the step (i), the step 503 of FIG. 5). The electronic bank server 10 displays the two-dimensional code including the URL (Uniform Resource Locator) of the web page for downloading the dedicated application software for opening an account available for a mobile-phone and also including the applicant identifying information on the window of the PC 30 via the web content. The applicant identifying information may be the identification information or the registry number (the step (i), the step 504 of FIG. 5).

When the mobile-phone 20 reads the two-dimensional code, the URL of the web page for downloading and the applicant identifying information are extracted so that the dedicated application software for opening an account available for a mobile-phone can be downloaded to the mobile-phone 20 via the web content showed by the URL (the step (k), the steps 506 and 507 of FIG. 5). The subsequent steps (the above-mentioned steps (e′), (f′) and (g′)) are the same as the steps (e), (f) and (g) of the first method.

The third method comprises the steps of:

(l) in the mobile-phone 20, entering the identification information including at least name, address and birth date, input by the applicant, via the web content for opening an account, which is provided by the electronic bank server 10:
(m) in the electronic bank server 10, storing the identification information input via the web content while being associated with the registry number for identifying the identification information in the application information DB 14;
(n) in the electronic bank server 10, generating the web page including the URL (Uniform Resource Locator) information of the web page for downloading the dedicated application software for opening an account available for a mobile-phone, which is associated with the applicant identifying information including the identification information or the registry number and sending the generated web page to the mobile-phone 20;
(o) in the mobile-phone 20, by appointing the URL on the mobile-phone 20, downloading the application software inheriting the applicant identifying information;
(e′) in the mobile-phone 20, by use of the downloaded application software, sending the digital data generated by photographing the identification document with the camera mounted on the mobile phone with camera 20 and the applicant identifying information to the electronic bank server 10;
(f′) in the electronic bank server 10, storing the character data based on the digital data of the identification document while being associated with the registry number identified by the applicant identifying information to the application information DB 14; and
(g′) in the electronic bank server 10, checking the character data based on the digital data of the identification document associated with the registry number and the identification information associated with the registry number, and then storing the identification information to the bank account DB 15 as a new bank account information.

In the second method, the PC 30 carries out the identification procedure, generates the two-dimensional code which is an information code including the applicant identifying information and the URL (Uniform Resource Locator) information of the web page for downloading the dedicated application software for opening an account available for a mobile-phone, and then provides the code to the PC 30 as the web content. Then, the mobile-phone 20 reads the two-dimensional code to generate the digital data of the identification document and sends the data to the electronic bank server 10.

In the third method, the identification information is input via the web content displayed on the window of the mobile-phone 20, and the electronic bank server 10 stores the input identification information while being associated with the registry number in the application information DB 14 (the steps (l) and (m), the steps 601 to 603 of FIG. 6). Then, the web page including the URL information of the web page for downloading the dedicated application software for opening an account available for a mobile-phone, associated with the applicant identifying information, is displayed on the window of the display of the mobile-phone 20 (the step (n), the steps 604 and 605 of FIG. 6). When the user operates the mobile-phone 20 to appoint the URL, the dedicated application software for opening an account available for a mobile-phone is downloaded. Since the downloaded dedicated application software for opening an account available for a mobile-phone inherits the applicant identifying information, the mobile-phone 20 can obtain the applicant identifying information (the step (o), the step 606 of FIG. 6). The subsequent steps (the above-mentioned steps (e′), (f′) and (g′)) are the same as the steps (e), (f) and (g) of the first method.

The present invention is not to be limited to the disclosed embodiments; but, is intended to cover various modifications included within the sprit and scope of the appended claims.

For example, in the aforesaid embodiment, the data converting processing unit 13 of the electronic bank server 10 generates the character data based on the digital data of the identification document. Otherwise, the character data based on to the digital data of the identification document may be generated at the mobile-phone 20 by executing the dedicated application software for opening an account available for a mobile-phone which has been downloaded to the mobile-phone 20. In this case, the character data based on to the digital data of the identification document is sent to the electronic bank server 10 from the mobile-phone 20. The electronic bank server 10 stores the received character data while being associated with the registry number in the application information DB 14, and compares (verifies) the character data with the identification information associated with the registry number.

1. A method for opening an account to a financial institution comprising steps of:
in a mobile terminal, downloading a dedicated application software for opening an account available for a mobile-phone, which are provided by web content for opening an account;
in said mobile terminal, by use of said downloaded application software for a mobile-phone, sending identification information including at least name, address and birth date, which are input by an applicant, to a server of the financial institution, connected to the said mobile terminal via a network;
in said server of the financial institution, storing the identification information while being associated with a registry number for identifying the identification information in an application information database;
in said mobile terminal, obtaining said registry number;
in said mobile terminal, by use of said application software for a mobile-phone, sending digital data generated by photographing the identification document with a camera mounted on said mobile terminal together with the registry number to said server of the financial institution;
in said server of the financial institution, storing character data based on said digital data of the identification document while being associated with the registry number in said application information database; and
in said server of the financial institution, checking the character data based on the digital data of the identification document associated with the registry number and the identification information associated with the registry number, and then storing the identification information in an account database as new account information.

2. A method for opening an account to a financial institution comprising steps of:
in a PC terminal, entering identification information including at least name, address and birth date, which is input by an applicant, via a web content for opening an account, which is provided by a server of the financial institution;
in said server of the financial institution, storing the identification information, input via the web content, while being associated with a registry number for identifying the identification information in an application information database;
in said server of the financial institution, generating a two-dimensional code which is an information code including applicant identifying information containing the identification information or the registry number and also including URL (Uniform Resource Locator) information of a web page for downloading a dedicated application software for opening an account available for a mobile-phone, and providing the code to said PC terminal as a web content;
in a mobile terminal in which said two-dimensional code is read, downloading said application software inheriting the user information, such as the applicant identifying information;
in the mobile terminal, by use of said downloaded application software for a mobile-phone, sending digital data generated by photographing the identification document with a camera mounted on said mobile terminal together with the applicant identifying information to said server of the financial institution;
in said server of the financial institution, storing character data based on the digital data of the identification document while being associated with the registry number identified by the applicant identifying information in said application information database; and
in said server of the financial institution, checking the character data based on the digital data of the identification document associated with the registry number and the identification information associated with the registry number, and then storing the identification information in an account database as new account information.

3. A method for opening an account to a financial institution comprising steps of:
in a mobile terminal, entering identification information including at least name, address and birth date, which is input by an applicant, via a web content for opening an account, which is provided by a server of the financial institution;
in said server of the financial institution, storing the identification information, input via the web content, while being associated with a registry number for identifying the identification information in an application information database;
in said server of the financial institution, generating a web page including URL (Uniform Resource Locator) information of the web page for downloading a dedicated application software for opening an account available for a mobile-phone, associated with applicant identifying information containing the identification information or the registry number, and providing the generated web page to said mobile terminal;
in said mobile terminal, by appointing said URL on said mobile terminal, downloading said application software inheriting the applicant identifying information;
in said mobile terminal, by use of said downloaded application software for a mobile-phone, sending digital data generated by photographing the identification document with a camera mounted on said mobile terminal together with the applicant identifying information to said server of the financial institution;
in said server of the financial institution, storing character data based on the digital data of the identification document while being associated with the registry number identified by the applicant identifying information in said application information database; and
in said server of the financial institution, verifying the character data based on the digital data of the identification document associated with the registry number and the identification information associated with the registry number, and then storing the identification information in an account database as new account information.

4. A method for opening an account to a financial institution according to any one of claims 1 to 3, wherein, in the step of, in said mobile terminal, sending the digital data of the identification document to said server of the financial institution,
information showing type of the identification document is sent to said server of the financial institution,
in said server of the financial institution, the character data based on the digital data of the identification document is generated according to the information showing type of the identification document, and the character data is verified with the identification information.

5. A method for opening an account to a financial institution comprising steps of:
in a mobile terminal, downloading a dedicated application software for opening an account available for a mobile phone, which is provided by a web content for opening an account;
in said mobile terminal, by use of the downloaded application software for a mobile-phone, sending identification information including at least name, address and birth date, which is input by an applicant, to a server of the financial institution connected to said mobile terminal via a network;
in said server of the financial institution, storing the identification information while being associated with a registry number for identifying the identification information in an application information database;
in said mobile terminal, obtaining the registry number;
in said mobile terminal, by use of said application software for a mobile-phone, generating digital data by photographing the identification document with a camera mounted on said mobile terminal and then generating character data based on the digital data;
in said mobile terminal, by use of said application software for a mobile-phone, sending the character data based on the digital data of the identification document together with the registry number to said server of the financial institution;
in said server of the financial institution, storing the character data based on the digital data of the identification document while being associated with the registry number in said application information database; and
in said server of the financial institution, checking the character data based on the digital data of the identification document associated with the registry number and the identification information associated with the registry number, and then storing the identification information in an account database as new account information.

6. A method for opening an account to a financial institution comprising steps of:
in a PC terminal, entering identification information including at least name, address and birth date, which is input by an applicant, via a web content for opening an account, which is provided by a server of the financial institution;
in said server of the financial institution, storing the identification information, input via the web content, while being associated with a registry number for identifying the identification information in an application information database;
in said server of the financial institution, generating a two-dimensional code which is an information code including applicant identifying information containing the identification information or the registry number and also including URL (Uniform Resource Locator) information of a web page for downloading a dedicated application software for opening an account available for a mobile-phone, and providing the code to said PC terminal as web content;
in a mobile terminal in which said two-dimensional code is read, downloading the application software inheriting user information, such as the applicant identifying information;
in said mobile terminal, by use of said downloaded application, generating digital data by photographing the identification document with a camera mounted on said mobile terminal, and then generating character data based on the digital data of said identification document;
in said mobile terminal, by use of said application software for a mobile-phone, sending the character data based on the digital data of the identification document together with the registry number to said server of the financial institution;
in said server of the financial institution, storing the character data based on the digital data of the identification document while being associated with the registry number identified by the applicant identifying information in said application information database; and
in said server of the financial institution, checking the character data based on the digital data of the identification document associated with the registry number and the identification information associated with the registry number, and then storing the identification information in an account database as new account information.

7. A method for opening an account to a financial institution comprising steps of:
in a mobile terminal, entering identification information including at least name, address and birth date, which is input by an applicant, via a web content for opening an account, which is provided by a server of the financial institution;
in said server of the financial institution, storing the identification information, input via the web content, while being associated with a registry number for identifying the identification information in an application information database;
in said server of the financial institution, generating a web page including applicant identifying information associated with the identification information or the registry number and URL (Uniform Resource Locator) information of a web page for downloading a dedicated application software for opening an account available for a mobile-phone, and providing the generated web page to said mobile terminal;
in said mobile terminal, by appointing the URL on said mobile terminal, downloading said application software inheriting the applicant identifying information;
in said mobile terminal, by use of said downloaded application software, generating digital data by photographing the identification document with a camera mounted on said mobile terminal, and then generating character data based on the digital data of said identification document;
in said mobile terminal, by use of said application software for a mobile-phone, sending the character data based on the digital data of the identification document together with the registry number to said server of the financial institution;
in said server of the financial institution, storing the character data based on the digital data of the identification document while being associated with the registry number identified by the applicant identifying information in said application information database; and
in said server of the financial institution, verifying the character data based on the digital data of the identification document associated with the registry number and the identification information associated with the registry number, and then storing the identification information in an account database as new account information.

8. A method for opening an account to a financial institution,
wherein an identification document required to submit to the financial institution in order to apply for opening a bank account is converted into digital data at a PC terminal or mobile terminal, and
the digital data of the identification document is sent to a server of the financial institution via a web content for opening an account, provided by said server of the financial institution, or via a network or e-mail.

9. A method for opening an account to a financial institution according to claim 8,
wherein the digital data of the identification document is generated by photographing the identification document with a camera mounted on the mobile-phone, and send to said server of the financial institution via a web content for opening an account, provided by said server of the financial institution, or via a network or e-mail.

10. A method for opening an account to a financial institution according to claim 8,
wherein access to web a site for opening an account providing the web content for opening an account is performed by clicking on a hyperlink for the web page which is a link source, or by reading said two-dimensional code using a mobile-phone provided with a function capable of reading a two-dimensional code which is an information code,
the hyperlink information includes URL (Uniform Resource Locator) information of the web site and user information which is inherited to the web site from said link source, and
said two-dimensional code includes URL (Uniform Resource Locator) information of the web site and the user information which is inherited to the web site.

11. A method for opening an account to a financial institution according to claim 9 or 10,
wherein executing the dedicated application software for opening an account available to a mobile-phone, at said mobile-phone, allows applying for opening a bank account to the financial institution, generating digital data of the identification document, and sending the digital data to said server of said financial institution continuously and consistently.

12. A method for opening an account to a financial institution according to claim 11,
wherein the dedicated application software for opening an account available for a mobile-phone is executed by linking to the web page including a button for downloading said application software, by selecting said button for downloading on the web page to download said application software to said mobile-phone via the web page, and then by activating said application software, at said mobile-phone.

13. A method for opening an account to a financial institution according to claim 9 or 10,
wherein an application for opening a bank account to the financial institution is accomplished by inputting identification information to said server of the financial institution from said PC terminal via a web content for opening an account,
a two-dimensional code which is an information code including applicant identifying information, such as the identification information, and URL (Uniform Resource Locator) information of a web page for downloading the dedicated application software for opening an account available for a mobile-phone is displayed on said PC terminal when the application for opening an account is completed by completing the input,
said two-dimensional code is read by said mobile-phone provided with a function capable of reading a two-dimensional code thereby to link to the web page with the user information such as the applicant identifying information being inherited,
a button for downloading on the web page is selected to download said application software to said mobile-phone via the web page with the user information being inherited, and
said application software is activated to generate digital data of the identification document and to send the digital data to said server of said financial institution, following the application for opening a bank account

14. A method for opening an account to a financial institution according to claim 9 or 10,
wherein an application for opening a bank account to the financial institution is accomplished by inputting identification information to said server of the financial institution from said mobile-phone via a web content for opening an account,
a button for sending the digital data is selected on the web page including buttons for selecting the method for sending the identifying document, at said mobile-phone, when the application for opening an account is completed by completing the input, in which hyperlink information obtained by selecting the button contains the applicant identifying information, such as the identification information, and the URL (Uniform Resource Locator) information of the web page for downloading the dedicated application software for opening an account available for a mobile-phone thereby to link to the web page for downloading with the user information, such as the applicant identifying information, being inherited;
a button for downloading on the web page for downloading is selected to download said application software to said mobile-phone via the web page with the user information being inherited, and
said application software is activated to generate digital data of the identification document and send the digital data to said server of said financial institution, following the application for opening a bank account.

15. A method for opening an account to a financial institution according to claim 8,
wherein, at said server of said financial institution, when the character data converted from the received digital data of the identification document is not recognized, notification for prompting to generate the digital data of the identification document and send it again is automatically sent to the transmitter of the digital data of the identification document via a network or e-mail, and is informed to the user via the web content for opening an account or the dedicated application software for opening an account available for a mobile-phone, or via e-mail, at said PC terminal or mobile terminal.

16. A method for opening an account to a financial institution according to claim 15,
wherein the received image information of the digital data of the identification document is converted into the character data by executing an OCR software, at said server of the financial institution.

17. A method for opening an account to a financial institution according to claim 8,
wherein the digital data of the identification document is sent with an optimized condition in photograph size and the like to said server of the financial institution or a network.
